(19) United States
(12) Patent Application Publication
(10) Pub. No.: US 2024/0416789 A1
(43) Pub. Date: Dec. 19, 2024

(54) METHOD AND APPARATUS FOR CHARGING ELECTRIC VEHICLES AND PROVIDING CHARGING STATION BASED DATA CENTER

(71) Applicant: Cisco Technology, Inc., San Jose, CA (US)

(72) Inventors: Chad M. Jones, Doylestown, OH (US); Joel Richard Goergen, Soulsbyville, CA (US); Robert Gregory Twiss, Chapel Hill, NC (US); Angelo Fienga, Roma (IT)

(21) Appl. No.: 18/358,349

(22) Filed: Jul. 25, 2023

Related U.S. Application Data
(60) Provisional application No. 63/508,100, filed on Jun. 14, 2023.

(51) Int. Cl. B60L 53/66; B60L 53/30; B60L 53/62; B60L 53/68

(52) U.S. Cl. CPC B60L 53/66; B60L 53/305; B60L 53/62; B60L 53/68

(57) ABSTRACT

A dual purpose electric charging station that includes a housing, a network interface configured to enable network communications and an electric charging interface configured to connect to an electric vehicle to charge a battery of the electric vehicle. The electric charging station further includes at least one server that is housed within the housing and includes at least one processor configured to perform one or more data center functions and a power module that distributes power to the electric charging interface and to the at least one server. Methods are also provided for a dual-purpose electric charging station that charges an electric vehicle and performs one or more functions of a cloud data center.

### CROSS-REFERENCE TO RELATED APPLICATION

This application claims the benefit of priority under 35 U.S.C. § 119(e) to U.S. Provisional Patent Application Ser. No. 63/508,100, entitled “DUAL PURPOSE CHARGING STATIONS FOR ELECTRIC VEHICLES,” filed on Jun. 14, 2023, which is hereby incorporated by reference in its entirety.

### TECHNICAL FIELD

The present disclosure relates to electric vehicle charging, power distribution, data management, and data communications.

### BACKGROUND

Electric vehicles (EV) are becoming more common. This leads to substantially increasing availability of charging stations globally. To address this, the number of charging stations will increase significantly in the future. On the other hand, nowadays, the average utilization rate of a charging station is less than fifty percent. While it is likely to increase, at least a portion of the time, the charging station will remain not used. The charging station has power and bandwidth at its disposal (because it is connected and may even be a fiber connection) that is being wasted i.e., not used.

### BRIEF DESCRIPTION OF THE DRAWINGS

FIGS. 1A and 1B are views illustrating a charging station based data center in a commercial setting and a residential setting, respectively, according to example embodiments.

FIG. 2 is a diagram illustrating a charging station based data center charging an electric vehicle (EV), according to an example embodiment.

FIGS. 3A-3C are diagrams illustrating various power distributions of a charging station, according to example embodiments.

FIG. 4 is a diagram illustrating a charging station based data center with a server blade storage, according to an example embodiment.

FIGS. 5A and 5B are diagrams illustrating environmental controls for the charging station based data center, according to one or more example embodiments.

FIG. 6 is a diagram illustrating a network of charging stations with a shared power distribution, according to an example embodiment.

FIG. 7 is a diagram illustrating a system for managing the use of charging stations, according to an example embodiment.

FIG. 8 is a block diagram illustrating a charging station block that includes components of the charging station for power distribution and communications with the cloud services of FIG. 7, according to an example embodiment.

FIG. 9 is a diagram illustrating a power distribution system in which power is distributed among a plurality of charging stations, according to an example embodiment.

FIG. 10A is a diagram illustrating a method of allocating and sharing power at a charging station, according to an example embodiment.

FIGS. 10B and 10C are views illustrating various power use profiles for a dual purpose charging station that charges an electric vehicle and powers one or more server blade, according to one or more example embodiments.

FIG. 11 is a block diagram illustrating components of the charging station based data center, according to an example embodiment.

FIG. 12 is a flow diagram illustrating a method of performing at least one data center function and/or charging an electric vehicle, by a dual purpose charging station, according to an example embodiment.

FIG. 13 is a hardware block diagram of a computing device that may perform functions associated with any combination of operations in connection with the techniques depicted and described in FIGS. 1-12, according to various example embodiments.

### DESCRIPTION OF EXAMPLE EMBODIMENTS

### Overview

Briefly, methods are presented for deploying multiple server blades in electric charging stations. These charging stations run the server blades to support various cloud/distributed functions of a distributed data center. The charging stations have space and capacity to house these server blades and have power to enable these server blades to run various compute functions and/or host applications when not in use by an electric vehicle (EV) for charging. The charging station may power down the server blades while the EV is being charged.

In one form, an apparatus is provided. The apparatus includes a housing and a network interface configured to enable network communications. The apparatus further includes an electric charging interface configured to connect to an electric vehicle to charge a battery of the electric vehicle and at least one server that is housed within the housing and includes at least one processor configured to perform one or more data center functions. The apparatus further includes a power module that distributes power to the electric charging interface and to the at least one server.

In another form, a method is provided, which includes an electric charging station obtaining power from one or more power sources. The electric charging station includes a charging interface that charges a battery of an electric vehicle connected thereto and at least one server that performs at least one data center function. The method further includes determining available power for use by the electric charging station based on a first power required for charging the battery of the electric vehicle and based on a second power required for performing the at least one data center function. The method further includes distributing the power among the charging interface and the at least one server based on the available power.

In yet another form, a system is provided. The system includes a plurality of electric charging stations. Each of the plurality of electric charging stations include an electric charging interface that connects to an electric vehicle to charge a battery of the electric vehicle. At least two charging stations of the plurality of electric charging stations include one or more servers that are configured to perform one or more data center functions of a distributed data center. The system further includes a power source that supplies power to the plurality of electric charging stations and a cloud service that controls the power source to distribute the power among the plurality of electric charging stations to charge one or more electric vehicles connected thereto and to perform the one or more data center functions of the distributed data center.

### EXAMPLE EMBODIMENTS

Server blades can be placed in electric vehicles (EVs) and leverage computing power of those server blades for various electric vehicle functions and cloud-computing functions. Due to the massive cost of building or expanding data centers, there has been a push to look for alternative methods to expand the compute footprint and the application hosting footprint. In addition, a demand for edge-compute capabilities as close as possible to the application users has resulted in a desire for flexible, low-cost, and easy-to-deploy/provision environments.

The techniques presented herein deploy multiple server blades in electric charging stations. These charging stations run the server blades to support various cloud/distributed functions of a distributed data center. The charging stations have space and capacity to house these server blades and have power to enable these server blades to run various compute functions and/or host applications when not in use by an electric vehicle (EV) for charging. Moreover, charging stations typically have a backup power source. These backup power sources may also be used for data centers. The charging station distributes the power for charging the EV and powering the server blades.

For example, the charging station may power down the server blades while the EV is being charged. As another example, the charging station may place the server blades in a low power standby mode to charge the EV. As yet another example, the charging station may switch to a slow charging mode (i.e., reduce the power for charging the EV) to allow the server blades to perform an urgent task. These are just some non-limiting examples of the charging station distributing power among the server blades and the charging of the EV.

In one or more example embodiments, the charging station is also a server depository that stores server blades. When a server blade, e.g., installed in the EV, is faulty/bad, the owner of the EV swaps the bad server blade with a server blade stored within the charging station. The charging station may then inform a control center that it has a bad server blade and/or turn on an indicator (i.e., a light) indicating that one or more faulty server blades are stored therein so that a repair technician may replace the malfunctioning server blade(s).

In one or more example embodiments, the charging station may use one or more power sources such as an alternating current (AC) power source, a solar power source, and/or a fault managed power (FMP) source. The FMP may be used in various ways by the charging station for charging the EV, providing power to the server blades hosted therein and/or the EV server blades, power sharing, and/or for data communications.

The term “Fault Managed Power” (FMP) (also referred to as Extended Safe Power (ESP)) as used herein refers to power operation delivered on one or more wires or wire pairs. FMP may use pulse power or other types of power. That is, FMP may be accomplished in a non-pulsing manner. FMP may involve fault sensing with or without the use of pulse power. As described below, power and data may be transmitted together (in-band) on at least one wire pair. FMP also includes fault detection (e.g., fault detection (safety testing) at initialization and between high voltage pulses), and pulse synchronization between power sourcing equipment (PSE) and a powered device (PD). The power may be transmitted with communications (e.g., bi-directional communications) or without communications.

The term “pulse power” (also referred to as “pulsed power”) as used herein refers to power that is delivered in a sequence of pulses (alternating low direct current voltage state and high direct current voltage state) in which the voltage varies between a very small voltage (e.g., close to 0V, 3V) during a pulse-off interval and a larger voltage (e.g., >12V, >24V) during a pulse-on interval. High voltage pulse power (e.g., >56 VDC, >60 VDC, >300 VDC, ˜108 VDC, ˜380 VDC) may be transmitted from power sourcing equipment to a powered device for use in powering the powered device, as described, for example, in U.S. Pat. No. 11,063,630 (“Initialization and Synchronization for Pulse Power in a Network System”). Pulse power transmission may be through cables, transmission lines, bus bars, backplanes, PCBs (Printed Circuit Boards), and power distribution systems, for example. It is to be understood that the power and voltage levels described herein are only examples and other levels may be used.

As noted above, safety testing (fault sensing) may be performed through a low voltage safety check between high voltage pulses in the pulse power system. Fault sensing may include, for example, line-to-line fault detection with low voltage sensing of the cable or components and line-to-ground fault detection with midpoint grounding. The time between high voltage pulses may be used, for example, for line-to-line resistance testing for faults and the pulse width may be proportional to DC (Direct Current) line-to-line voltage to provide touch-safe fault protection. The testing (fault detection, fault protection, fault sensing, touch-safe protection) may comprise auto-negotiation between power components. The high voltage DC pulse power may be used with a pulse-to-pulse decision for touch-safe line-to-line fault interrogation between pulses for personal safety.

In one or more embodiments, FMP (FMP/ESP) may comprise pulse power transmitted in multiple phases in a multi-phase pulse power system with pulses offset from one another between wires or wire pairs to provide continuous power. One or more example embodiments may use multi-phase pulse power to achieve less loss, with continuous uninterrupted power with overlapping phase pulses, as described in U.S. Pat. No. 11,456,883 (“Multiple Phase Pulse Power in a Network Communications System.

FMP may be converted into Power over Ethernet (PoE) and used to power electrical components within the electric charging station. In one or more example embodiments, power may be supplied using Single Pair Ethernet (SPE) and may include data communications (e.g., 1-10GE (Gigabit Ethernet)). The power system may be configured for PoE (e.g., conventional PoE or PoE+ at a power level <100 watts (W), at a voltage level <57 volts (V), according to IEEE 802.3af, IEEE 802.3at, or IEEE 802.3bt), Power over Fiber (PoF), advanced power over data, FMP, or any other power over communications system in accordance with current or future standards, which may be used to pass electrical power along with data to allow a single cable to provide both data connectivity and electrical power to components (e.g., battery charging components, server data components, electric vehicle components).

In one or more example embodiments, the electric charging stations are self-adaptive. That is, the electric charging stations may perform predictive planning for use of their resources (server blades). The charging station may analyze use-history data and real-time data (reservations). Predictive planning for the use of the server blades for cloud/distributed functions of a distributed data center is based on these analyses. The charging stations allocate power to server blades and/or perform various computational tasks using the server blades based on this planning.

In one or more example embodiments, the charging stations include an environment control mechanism for cooling/heating server blades installed therein. In one example embodiment, the charging station includes a heat pump and a sensor. When the temperature is below approximately ˜40° C. (low temperature threshold), the heat pump circulates heated air or fluid to maintain the temperature above the low temperature threshold. When the temperature is above 55° C. (high temperature threshold), the heat pump circulates air or fluid to cool the server blades to maintain the temperature below the high temperature threshold. The environmental control mechanism involves stable air and/or fluids circulating around the server blade stack. The server blades may be placed close to the ground or even below the ground and/or air sealed. Having the server blades below the concrete/ground improves cooling. A lifting mechanism is then provided for swapping server blades when the charging station is used as the server depository.

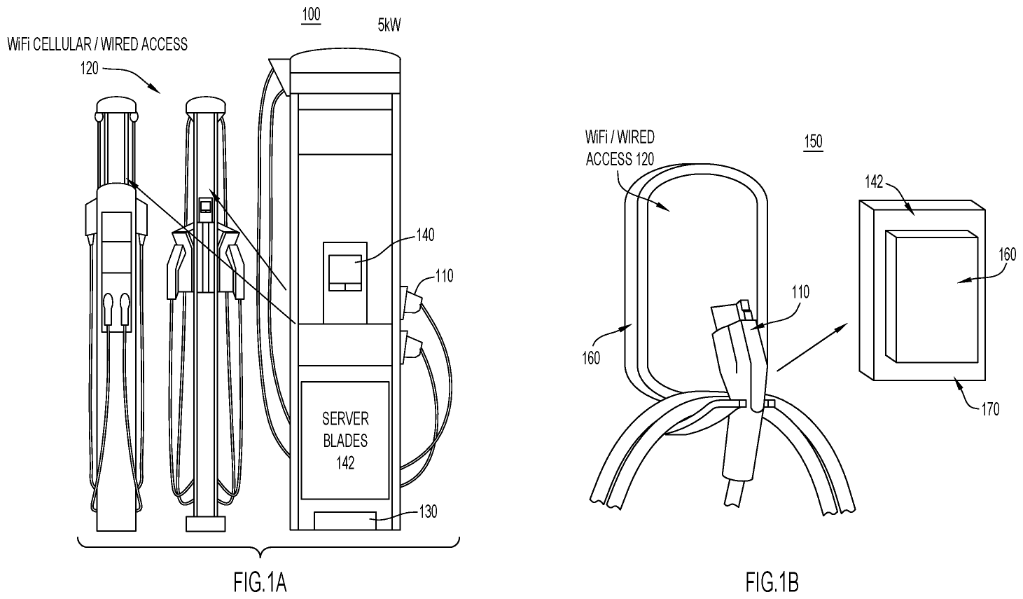

FIGS. 1A and 1B are views illustrating a first charging station based data center 100 in a commercial setting and a second charging station based data center 150 in a residential setting, respectively, according to example embodiments.

In FIG. 1A, the first charging station based data center 100 is an example of an industrial charging station that may be deployed in a commercial setting or a public space such as a parking area. The first charging station based data center 100 may be a stand-alone unit (module, device, apparatus, components). The first charging station based data center 100 includes charging interface 110, a communication interface 120, a power source 130, an authentication module 140, and server blades 142. These components are placed within a housing of the first charging station based data center 100 with the charging interface 110 extending from the housing of the first charging station based data center 100.

The charging interface 110 (e.g., a hose) connects to the EV to electrically charge one or more batteries within the EV and/or to perform one or more communications with the EV. The first charging station based data center 100 may output power in a range of 5 kW to 300 kW (e.g., 300 kW is fast charging stations). The first charging station based data center 100 may operate in various charging modes according to various charging profiles such as a fast charging mode of approximately 300 kW to 500 kW (e.g., mode 4), a regular charging mode of approximately 100 kW to 250 kW (e.g., mode 4), and a slow charging mode of approximately less than 100 kW.

The communication interface 120 enables one or more network communications such as Wifi, cellular, and/or wired access. The first charging station based data center 100 may be coupled to a data source (e.g., Internet or other data network(s)).

The power source 130 powers the first charging station based data center 100. Power received at the first charging station based data center 100 may be, for example, utility Alternating Current (AC) power, Direct Current (DC) power, FMP, and/or power from an alternative energy source such as a solar power system and/or a wind power system (e.g., 380 VDC or other voltage).

The received power and data may be combined and converted to Fault Managed Power (FMP) and transmitted to power the server blades 142 and/or to charge the battery in the EV. The FMP may include a bi-directional FMP multi-drop system that allows the utility power or other sources such as solar or regenerative motor energy to power the first charging station based data center 100.

Example embodiments described herein allow for conversion of an entire power distribution system to FMP in a single pair or multi-pair system, while providing safety features. For example, the use of FMP (power and data with safety features) for all power systems from or to the battery of the EV or utility power provides for safe interaction when emergency personnel are responding to a charging station incident.

FMP utilizes pulse power with testing between high voltage pulses to provide a safe high-power distribution system. That is, FMP allows for the transfer of 380 VDC or other DC voltage between a source and destination using pulse power and evaluating safety between high voltage pulses. In one example, FMP comprises a plurality of voltage pulses (sequence of voltage pulses) in which voltage varies between a small voltage during a pulse-off time a and a larger voltage during a pulse-on time (high voltage pulse). The FMP may be transmitted as single-phase pulse power over a wire pair or as multi-phase pulse power over multiple wire pairs. The safety testing between high voltage pulses in the FMP system allows a source to shut down automatically when power wires are exposed to an unintentional load such as from contact with a person. The FMP based system may also support GE (Gigabit Ethernet) data transfer over a single twisted pair, for example. The system provides for fast data analytic off-loading and moving of server data or other data intensive communications activity using 1 GE, 10 GE, or faster communications over FMP wiring while the first charging station based data center 100 charges EV batteries of the EV.

The authentication module 140 authenticates the EV with respect to the first charging station based data center 100. Further, the authentication module 140 may authenticate the fault managed power and FMP based communications for the first charging station based data center 100 and data center functions, thereby allowing for a secure trust layer to ensure that the communications and charging power are all trusted. The authentication module 140 verifies proper FMP transmitter to FMP receiver interfaces and connections to allow only trusted charging stations to transmit or receive FMP i.e., to the EVs and/or to other data center location(s). The authentication module 140 may be used to prevent destruction of the first charging station based data center 100 deployed in public locations by controlling access to communications and use of the first charging station based data center 100. Some authentication mechanisms are described in US Patent Publication 2022/0063429, published Mar. 3, 2022.

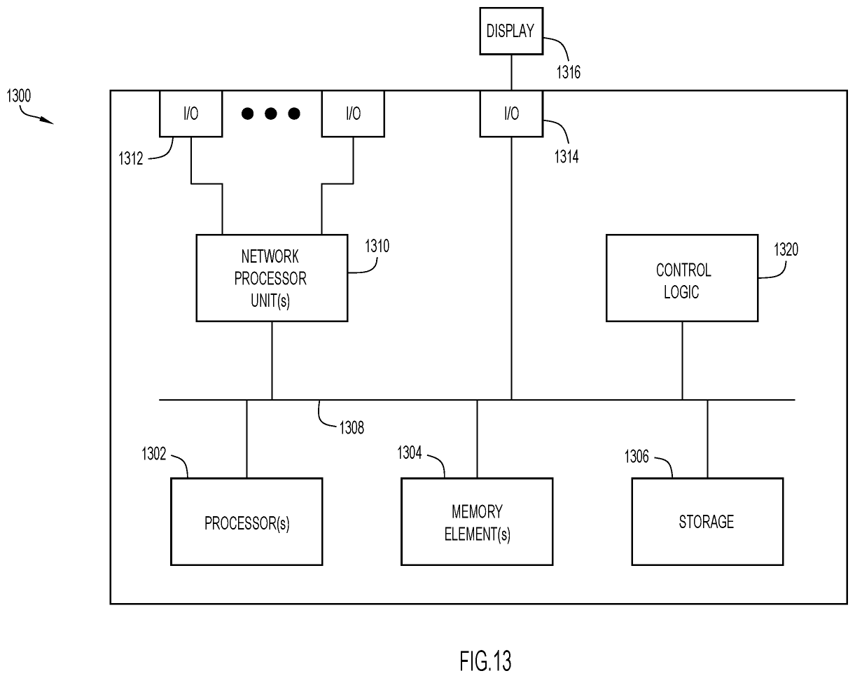

The server blades 142 form a cloud data center and may provide data functions to support and operate as an enterprise data center, hyperscale data center, telecom data center, managed services data center, or any other type of data center. The server blades 142 are processors and/or computing devices, each of which may include one or more components described in FIG. 13.

The number of servers may vary widely (e.g., 10, 50, 550, 1,000, 5,000, 10,000, >10,000, or any other number of servers) depending on a particular deployment and use/case scenario. One or more server blades are positioned in any suitable location within the first charging station based data center 100. Also, while a box is shown to depict the server blades 142, it is to be understood that the server blades 142 may be cubic or any other suitable shape to allow space for other functions of the first charging station based data center 100 and may be positioned in any location in which sufficient space is available in the first charging station based data center 100.

The server blades 142 may also be configured such that servers or server appliances may be easily added or removed especially when the first charging station based data center 100 is also used as a storage repository for the server appliances. The server blades 142 may be modular, enterprise maintained, operable with low power usage, and easily upgraded. Different types of the server blades 142 may be provided in the first charging station based data center 100. For example, a first server set performs functions of the cloud data center and a second server set includes EV type server blades for replacement of faulty server blades inside the EV. The first server set may be positioned below the ground for improved cooling in an air sealed separate housing and the second server set may be positioned at a location that is easily accessible by users (e.g., EV operators and/or repairmen).

In FIG. 1B, the second charging station based data center 150 may include analogous features and functions to the ones described above with respect to the first charging station based data center 100 of FIG. 1A, according to an example embodiment. The second charging station based data center 150 includes the charging interface 110, the communication interface 120, server blades 142, a charging mechanism 160, and a server depository 170.

In this disclosure, same numeric references denote analogous features. The second charging station based data center 150 is configured to charge a battery of the EV using the charging interface 110 and to store the server blades 142 in the server depository 170.

The second charging station based data center 150 is an example of a residential charging station that may be deployed in a user's home e.g., garage, side of the house near a driveway, etc. The second charging station based data center 150 may receive power from the residential house and use wifi/wired access of the house. That is, the second charging station based data center 150 uses the communication interface 120 to communicate with the power source at the house and/or to transmit/receive data from a cloud data center.

The second charging station based data center 150 may output 1 kW to 12 kW (e.g., slow charging mode) to charge the EV via the charging interface 110 using the charging mechanism 160. The charging mechanism 160 provides power to the charging interface 110, which may be a long hose with a connector to connect to or plug into the EV. In one example embodiment, the charging mechanism 160 may use AC power from a domestic power source installed at the house and convert it to DC power or FMP to charge the EV.

The server blades 142 are stored in the server depository 170 (e.g., storage), which allows easy access to the server blades 142 for removal and replacement for EV applications. Some of the server blades 142 may perform various computational and hosting functions. For example, a portion of the server blades 142 stores and/or hosts applications used by one or more computing devices within the residential house of the second charging station based data center 150. Another portion of the server blades 142 perform computational and/or hosting functions of an enterprise data center and yet another portion of the server blades 142 may be specific to the EV and are replacement servers for the served blades in the EV.

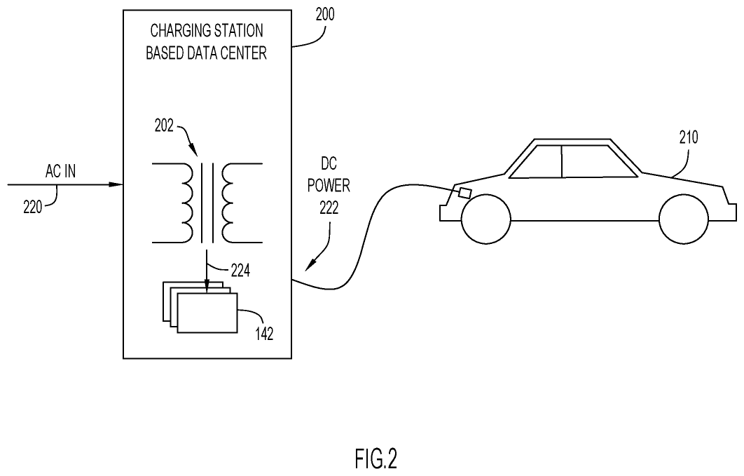

FIG. 2 is a diagram illustrating a charging station based data center 200 charging an electric vehicle (EV 210), according to an example embodiment. The charging station based data center 200 includes the server blades 142 and a power module 202. The charging station based data center 200 charges the EV 210.

As previously noted, utility power or power from solar or wind systems may be used to provide power at the charging station based data center 200. By way of an example, utility AC power is received by the charging station based data center 200. These are only examples and the charging station based data center 200 may be configured for receiving any type of usable power from any source. For example, the bi-directional FMP may be converted from or to power the charging station based data center 200.

Specifically, AC power is input to the power module 202, at 220 (AC in). The power module 202 converts AC power to DC power or converts the DC power to the AC power. In one example embodiment, the power module 202 may receive power from an AC outlet via an AC power plug and cable.

At 222, the power module 202 transmits the DC power to charge the battery of the EV 210. The charging rates vary depending on a particular deployment and use case. For example, the charging rate may vary from 4 kW to 800 kW in rapid charging. In an example embodiment, when the power is received via an AC outlet, slow charging mode is performed at approximately less than 50 kW i.e., level 1 or level 2 charging.

At 224, the power module 202 also powers the server blades 142 using the DC power, for example.

The charging station based data center 200 distributes power between charging the EV 210 and powering the server blades 142 to perform one or more compute or hosting operations i.e., data center functions. The power module 202 distributes the power between EV 210 and the server blades 142 based on priorities, required power, and/or available power.

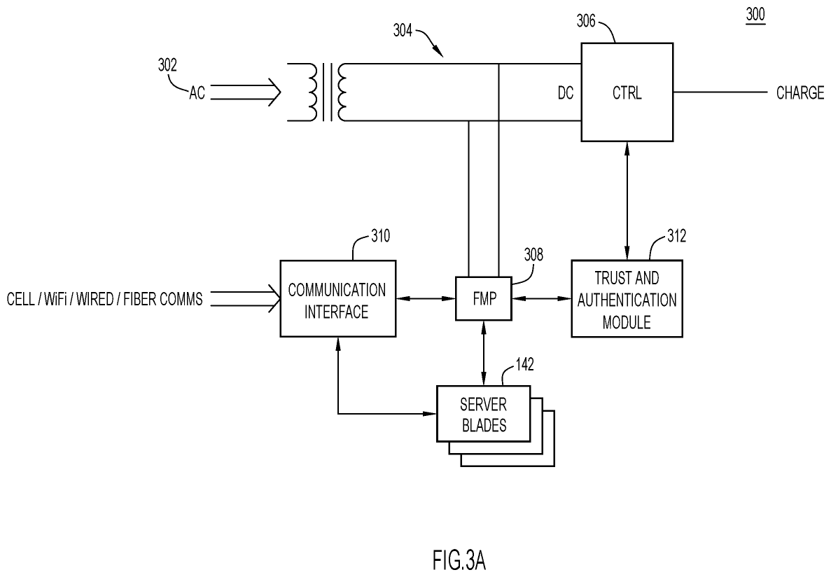

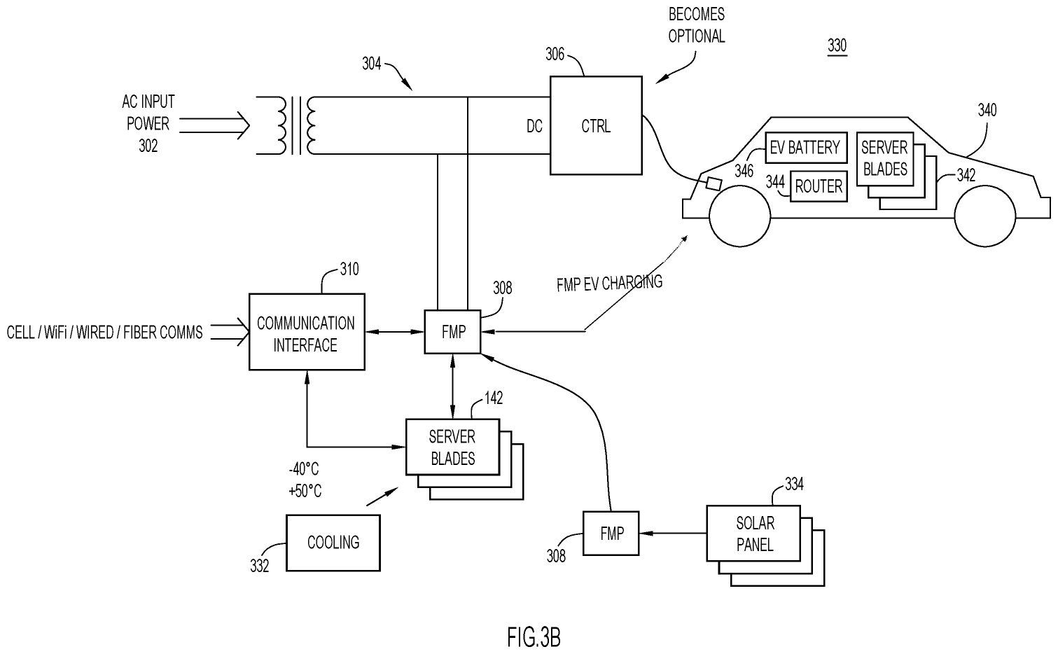

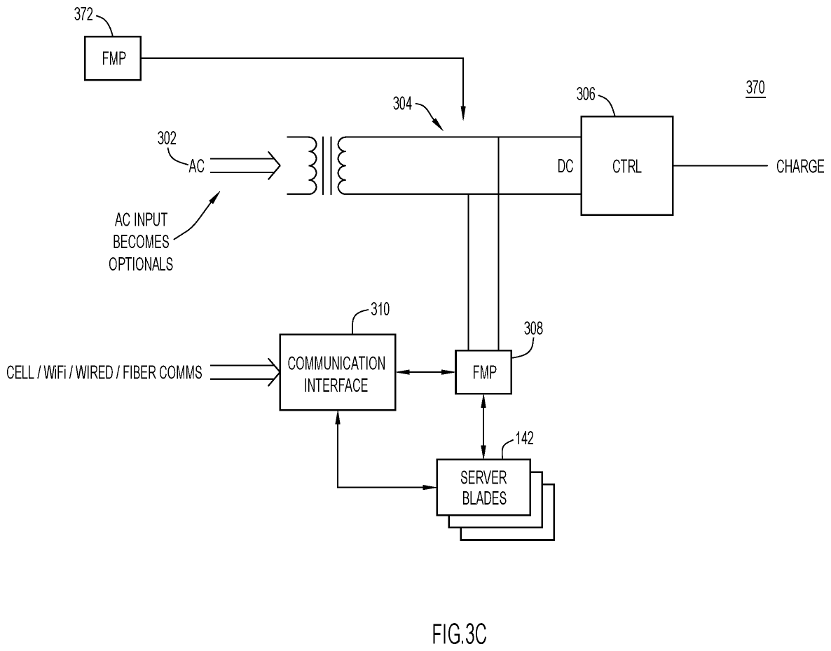

FIGS. 3A-3C are diagrams illustrating various power distributions of a charging station such as a first power distribution 300, a second power distribution 330, and a third power distribution 370, respectively, according to example embodiments.

These power distributions involve one or more of an AC input power 302, a power module 304, a controller 306, an FMP block 308, a communications module 310, a trust and authentication module 312, a cooling mechanism 332, an alternative power source 334 (e.g., solar), the server blades 142, and the FMP input power 372. These are only examples and the charging station may be configured for receiving any type of usable power from any source. The charging station also includes other components such as a housing, an opening that provides access to the server blades (replacement, faulty server blades, etc.), a lifting mechanism to move a server housing, one or more indicators to indicate that a faulty server blade is stored therein or availability of replacement server blades, etc.

Specifically, in FIG. 3A, the first power distribution 300 involves the AC input power 302, the power module 304, the controller 306, the FMP block 308, the communications module 310, the trust and authentication module 312, and the server blades 142.

In the first power distribution 300, the AC input power 302 is received by or input into the charging station i.e., the power module 304. For example, the AC input power 302 may be received via an AC outlet in case of a residential charging station. As another example, the AC input power 302 may be received from an AC utility grid in case of a commercial charging station.

The power module 304 converts the AC input power 302 into the DC power. The DC power is then provided to charge the battery in the EV under the control of the controller 306 and using a charging hose (not shown). The DC power is also provided to the FMP block 308 to power the server blades 142. For example, the DC power is provided to the FMP block 308 while the charging station is not being used to charge the battery in the EV. The DC power may be split between charging the battery in the EV and powering the server blades 142. The DC power may be provided to charge the battery in the EV only e.g., for the fast charging mode. The distribution of power may vary depending on required power, available power, and/or other parameters e.g., the charging profile for a selected charging mode.

In one example embodiment, the FMP block 308 and/or the controller 306 may change an operating state of the at least on server e.g., to a standby mode, based on a fast mode charging request. As another example, the FMP block 308 may reduce the power being supplied to the at least one server based on a charging profile, which utilizes all available power when in the middle of the charging of the battery of the EV.

The FMP block 308 is connected to the DC power (the power module 304). The FMP block 308 powers the server blades 142 for easy plug in/plug out. Using the FMP power from the FMP block 308, the server blades 142 perform various cloud/distributed functions of a distributed data center. The FMP block 308 may include an FMP transmitter (TX) and an FMP receiver (RX). Power and data are received at the FMP transmitter. The FMP transmitter then converts the power to FMP. In one example embodiment, the FMP may be delivered to the controller 306 for transmittal to the EV. Data received from the EV may also be transmitted to the FMP receiver (RX) and provided to the server blades 142. For example, a user may connect their EV for charging at home or work and upload or download data to or from the server blades 142 while the EV is charging.

The communications module 310 enables network communications outside of the charging station i.e., network processing unit (NPU). The communications module 310 includes connection to internet and/or other network(s). In one example embodiment, the communications module 310 includes a cellular module, wired, fiber optics, and/or a Wi-Fi in the communications module 310 e.g., a router. The router is in communication with the server blades 142. The communications module 310 transmits and receives data from an external entity (e.g., another server blade in a different charging station, cloud management entity, the EV, etc.). The communications module 310 may include a bi-directional FMP connection.

The trust and authentication module 312 performs authentication functions for connecting to the charging station. The trust and authentication module 312 performs access control for the EV that is using the charging station. Further, the trust and authentication module 312 performs access control before any data transfers are permitted. For example, the trust and authentication module 312 may instruct the controller 306 to shut down power and data if authentication fails. As another example, the trust and authentication module 312 may shut down power to the FMP block 308 if authentication fails. As another example, the trust and authentication module 312 may shut down communication between the server blades 142 and the communications module 310 based on a failed authentication.

In FIG. 3B, the second power distribution 330 involves the AC input power 302, the power module 304, the controller 306, the FMP block 308, the communications module 310, and the server blades 142. Examples of these components were described above with reference to the first power distribution 300 of FIG. 3A. The second power distribution 330 further involves the cooling mechanism 332 and the alternative power source 334.

In the second power distribution 330, the FMP is used instead of the DC power to charge the battery of the EV. That is, the FMP block 308 is used to power the server blades 142 and to perform FMP charging of the EVs. In one example embodiment, the power module 304 converts the AC input power 302 into the DC power and provides the DC power to the FMP block 308. The FMP block 308 then charges the EV connected thereto and/or connects to the server blades 142 for data transfer and/or to provide power. The controller 306 is no longer needed and may be omitted.

For example, the FMP block 308 may change the operation state of the server blades 142 i.e., to a standby mode or to reduce the power being supplied based on a request to charge the battery of the EV in a fast charging or regular charging mode. As another example, the FMP block 308 may adaptively control power supplied to server blades 142 such that at a starting state and finishing state, more power is supplied to the server blades 142 and at in progress state (in the middle of charging), power being supplied to server blades 142 is reduced or suspended (standby mode). In other words, a charging profile for the selected charging mode for charging the EV may be used to adjust the power between provided to the server blades 142. The FMP block 308 may suspend operations of the at least one server that performs the at least one data center function based on determining that the charging interface is charging the battery of the electric vehicle in the fast charging mode and is at the in progress state.

Additionally, as one of the parameters for allocating power among the charging of the EV and the data center functions, priority of the task to be performed by the server blades 142 may be used. The FMP block 308 may switch to a slow charging mode based on the priority of the request assigned or related to the server blades 142.

In one example embodiment, the cooling mechanism 332 is provided to cool the server blades 142. That cooling mechanism 332 may include one or more heat sinks that circulate cooling fluids around the server blades 142. The cooling mechanism 332 may further include fans, pumps, etc. The cooling mechanism 332 is configured to maintain the server blades 142 at a temperature below 55° C.

The cooling mechanism 332 is just one example of a temperature control mechanism. In one or more example embodiment, the temperature control mechanism may include a sensor to detect the temperature near the server blades 142 and further include a heating mechanism such as a heat pump that is configured to circulate warm air around server blades 142 if the detected temperature falls below −40° C.

The alternative power source 334 includes a solar power source that powers the cooling mechanism 332 and/or the server blades 142. In one example embodiment, the alternative power source 334 provides power to the FMP block 308, which converts it to the FMP. The FMP is then used to charge the battery in the EV and to power the server blades 142 when not used for charging. The solar power source is just an example of alternative power source 334 and other reusable sources of energy i.e., wind power, are within the scope of this disclosure.

In one example embodiment, an FMP transmitter may be integrated into the alternative power source 334 i.e., solar panel(s). The FMP transmitter in the alternative power source 334 transmits FMP to the components of the charging station i.e., to an FMP receiver such as the FMP block 308. That is, instead off microinverters receiving the solar power, which is then converted from DC power to AC power, by a main inverter, which is then supplied to a house and/or utility grid, the FMP transmitter directly supplies the FMP to the house and/or utility grid.

In one example embodiment, the FMP based on the DC power is used to charge the battery in the EV and to connect to the EV's server blades while the FMP based on solar power powers the server blades 142. The FMP block 308 thus charges the EV and powers the server blades 142 to perform data center functions. In other words, the FMP block 308 is further configured to allocate different types of power for different functions of the dual purpose charging station.

In one or more example embodiments, the server blades 142 (or cloud server blades) may determine that a task being performed is urgent and requires power not necessarily available at a charging station. The server blades 142 may then draw power from an EV 340 itself i.e., battery in the EV 340, using the FMP block 308. In other words, instead of using one or more of multiple power input sources such as the AC input power 302, power from a local battery (not shown), FMP power source (not shown) and/or the alternative power source 334, the server blades 142 use the EV 340 as the power source. The EV 340 delivers the power through the regular cable and/or the FMP block 308. The amount of power delivered from the EV 340 would be determined by a user and/or a cloud service (described below), based on power demands. This allows for bi-directional power transfer from the EV 340 in cases where grid or local power is unavailable and the server blade function is to continue to operate.

The EV 340 includes server blades 342 that may be in wireless communication with a cell tower or Wi-Fi device, and/or the charging station, as previously described, via a router 344, for example. The server blades 342 receives power from an EV battery 346. In one example, power is received at the router 344, which distributes power to the other components. Power may be delivered, for example, as PoE or ESP/FMP. In one example embodiment, the router 344 delivers FMP power to the server blades 142 in a charging station. In other words, the EV battery 346 is used to charge the server blades 142.

In FIG. 3C, the third power distribution 370 involves the power module 304, the controller 306, the FMP block 308, the communications module 310, and the server blades 142. The third power distribution 370 further involves the FMP input power 372 that powers components within the charging station.

Since the FMP input power 372 powers the charging station, the AC input power 302 becomes an optional feature, which may or may not be included in the charging station.

In one example embodiment, the FMP is bidirectional meaning the EV provides data via the FMP block 308 to the charging station. The FMP is bidirectional further meaning that the EV battery 346 of FIG. 3B may be used to power the server blades 142 in the charging station. Further, FMP may be used for EV charging and/or connecting to the EV's server blades. FMP powers the server blades 142 and/or further provides power for cooling the server blades 142.

In one example embodiment, when both power sources are provided (AC input power 302 and the FMP input power 372), the power may be combined and applied to the server blades 142 and/or to charge the EV under the control of the controller 306. As another variation, the AC input power 302 is used to charge the EV and the FMP input power 372 is used to power the server blades 142.

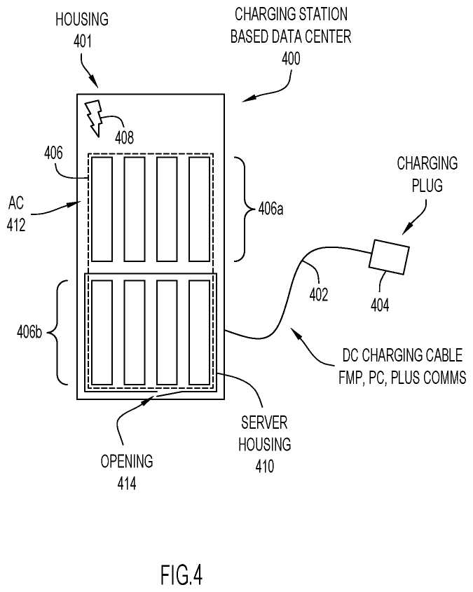

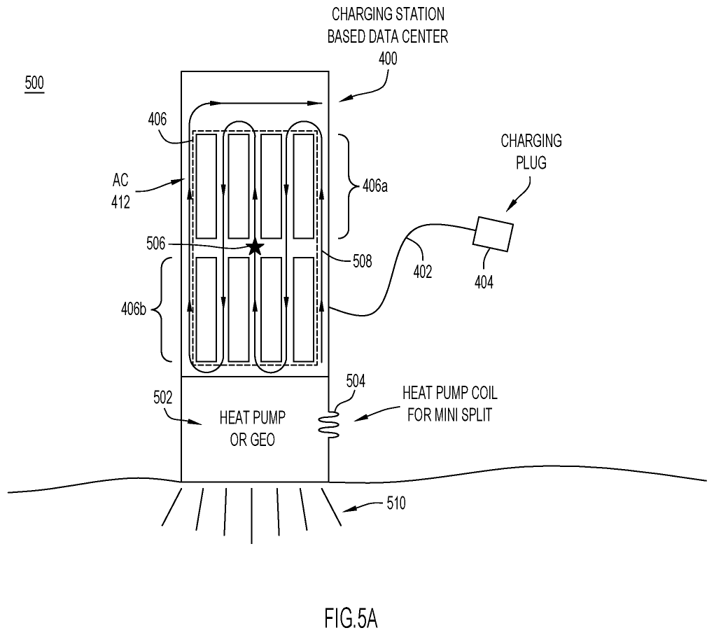

FIG. 4 is a diagram illustrating a charging station based data center 400 with a server blade storage, according to an example embodiment. The charging station based data center 400 includes a housing 401, a charging cable 402, a charging plug 404, a server blades stack 406, an indicator 408, and a server housing 410.

The housing 401 is a case that stores components of the charging station based data center 400 therein such as the server blades stack 406. The charging cable 402 extends outside of the housing 401. The housing 401 may include one or more indicators such as indicator 408 on an exterior service thereof. In one example embodiment, the indicator 408 may be provided on a user interface provided on an exterior surface of the housing 401.

The charging station based data center 400 receives input power, e.g., AC power at 412. The charging station based data center 400 charges one or more batteries in the EV via the charging cable 402 and charging plug 404. The charging cable 402 and the charging plug 404 may charge the EV using the DC power, FMP, etc. Further, the charging cable 402 and the charging plug 404 provide for data communications between the charging station based data center 400 and the EV connected thereto (not shown).

The server blades stack 406 includes an active server blades set 406a that perform data center functions (computing and/or hosting applications) and a replacement server blades set 406b. The active server blades set 406a may be outside the reach of a user e.g., at an upper portion of the housing 401. In addition to or alternatively, the active server blades set 406a may be sealed below the ground. The active server blade set 406a form a part of a distributed data center.

The replacement server blades set 406b includes server blades that are removable for replacement of faulty server blades in the EV or elsewhere. The replacement server blades set 406b may include different types of server blades specific for the EVs. The replacement server blades set 406b are stored in the server housing 410. The server housing 410 is a storage depository that includes an opening 414 providing access to the replacement server blades set 406b. For example, the opening 414 may be a door in the case. Based on a successful authentication, the user may open the door of the server housing 410 and remove a replacement server blade from the replacement server blades set 406b. The user then places the faulty server blade into the server housing 410 and closes the door. At which point the indicator 408 may be turned on to indicate that a faulty server blade is stored in server housing 410.

For example, the indicator 408 may include a first LED light that is green while replacement server blades are available and turns red when there are no replacement server blades left. The indicator 408 may include a second LED light that is green when no faulty server blades are stored therein and turn red when at least one faulty server blade is stored in the server housing 410. That is, when a server blade e.g., installed in the EV, is faulty/bad, the owner of the EV swaps or switches the bad server blade with a server blade stored in the charging station i.e., in the replacement server blades set 406b. The charging station based data center 400 may also inform a control center or a server appliance cloud manager that a bad server blade is stored therein. Further, a repair technician may take out or replace the bad server blade(s) when at the charging station based data center 400 based on the notification and/or the indicator 408.

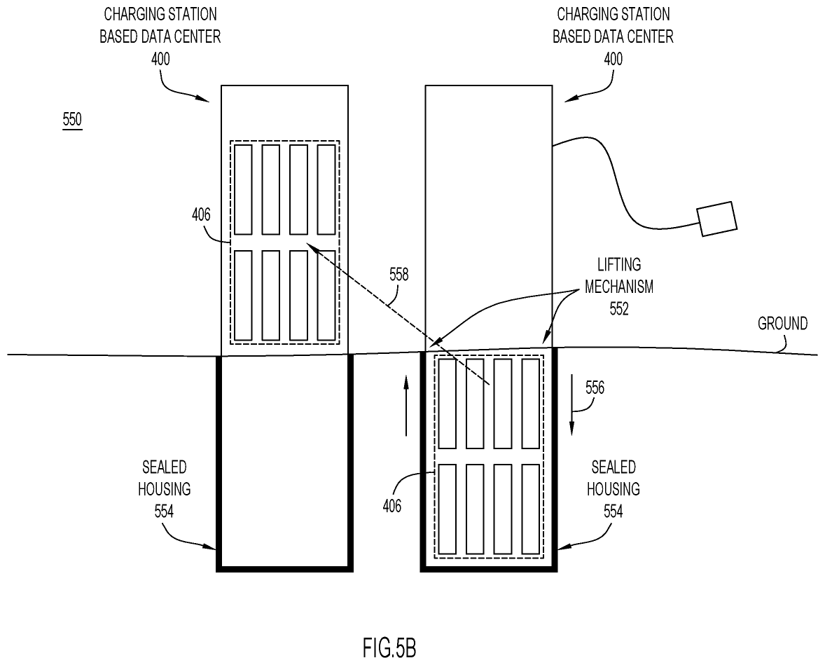

With continued reference to FIG. 4, FIGS. 5A and 5B are diagrams illustrating a first environmental control 500 and a second environmental control 550 for the charging station based data center 400, according to one or more example embodiments. The first environmental control 500 of FIG. 5A and the second environmental control 550 of FIG. 5B include environment control mechanisms for cooling and/or heating the server blades stack 406 installed therein.

The first environmental control 500 and the second environmental control 550 are operable to maintain the server blades above −40° C. and below 55° C., which may serve as a threshold values to trigger operations of an environmental control mechanism.

The first environmental control 500 includes a heat pump 502 and/or a coil 504 for mini split. The first environmental control 500 further includes a sensor 506 that measures temperature around the server blades stack 406. When the sensor 506 detects that the temperature is below approximately −40° C. (low temperature threshold value), the heat pump 502 and the coil 504 generates heated air and/or fluid, which is then circulated around the server blades stack 406, at 508. That is, the heated air or fluid is circulated to maintain the temperature above the low temperature threshold.

On the other hand, when the sensor 506 detects that the temperature is approximately 55° C. or above (a high temperature threshold value), the heat pump 502 and the coil 504 circulates cool air and/or fluid to cool the server blades stack 406, at 508. The heat pump 502 does not warm the air and/or fluid. In one example embodiment, the heat from the server blades stack 406 may further dissipate into the ground, at 510. The cool air and/or fluid is circulated and dissipated into the ground to maintain the temperature below the high temperature threshold value.

The environmental control mechanism involves stable air and/or fluids circulating around the server blades stack 406 to maintain the server blades in a proper temperature range. For a more efficient temperature control, the server blades stack 406 may be housed within the server housing 410 that is air sealed. The air and/or fluids are then circulated within server housing 410. In one example embodiment, an active server blade set 406a that forms a part of a distributed data center may be sealed within the server housing 410 and cooled/heated, whereas the replacement server blades set 406b is outside the server housing 410 and is cooled by being closer to the ground.

In FIG. 5B, the second environmental control 550 includes a lifting mechanism 552 and a sealed housing 554. The lifting mechanism 552 is configured to lower the server blades stack 406 below the ground, at 556 and above the ground, at 558.

The server blades of the server blades stack 406 may be placed below the ground e.g., at approximately 4 feet below the ground, at 556, and air sealed within a concrete sub-housing i.e., the sealed housing 554. The sealed housing 554 ensures that the server blades stack 406 stay dry and protects the server blades stack 406 against any water damage. Moreover, the heat from the server blades stack 406 dissipates into the ground. Since the temperature below the ground at approximately 4 feet is approximately 45-50° Fahrenheit, it is easier to keep the server blades stack 406 within the required temperature range i.e., easier to cool.

The lifting mechanism 552 is provided for swapping server blades in the server blades stack 406 when the charging station based data center 400 is used in part as a server depository. That is, when one or more servers in the server blades stack 406 are to be replaced, repaired, and/or swapped, the lifting mechanism is actuated to lift the server blades stack 406 and/or to lift the rack that holds the server blades stack 406. One or more servers may then be retrieved through an opening in the housing 401 of FIG. 4.

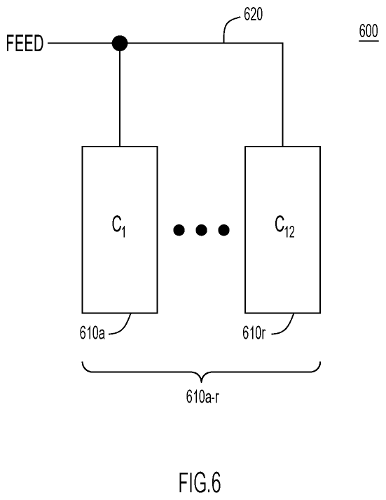

FIG. 6 is a diagram illustrating a network 600 of charging stations with a shared power distribution, according to an example embodiment. The network 600 includes a block of charging stations 610a-r and a common power and communications connection 620. The block of charging stations 610a-r may include at least two charging stations, a first charging station 610a and a second charging station 610r.

iShare and other applications allow users to reserve charging stations for their EVs. This information (reservations) is shared with the charging stations for predictive planning. Based on use-history data and real-time data (reservations), the charging stations allocate power to server blades to perform various compute tasks using the server blades. The charging stations determine when they are not in use for charging the EV and can perform at least part of the functions of the cloud data center. The charging stations are thus “self-adaptive”.

In one example embodiment, the block of charging stations 610a-r (C1-Cr) share input power e.g., AC, FMP, etc., via the common power and communications connection 620. The power may be 240V/60A. In one example embodiment, the power is FMP.

In a commercial use or public setting, the FMP is shared between the block of charging stations 610a-r. The shared power is allocated between charging function and compute function performed by these charging stations 610a-r via predictive planning. One or more of the charging stations 610a-r applies a control algorithm (machine learning, etc.) to determine power or current to draw from a shared power source via the common power and communications connection 620. The charging stations 610a-r may power down (i.e., decrease power and/or standby mode) their respective server blades for charging the EVs. The charging stations 610a-r use information from the reservation applications and use history to determine power needed and available power for distribution of power between charging an EV and powering the server blades. As such, the charging stations 610a-r are self-adaptive.

In another example embodiment, the charging station shares FMP with other components of an FMP powered house, in a residential or private setting. That is, the charging station may share power with one or more residential electric appliances.

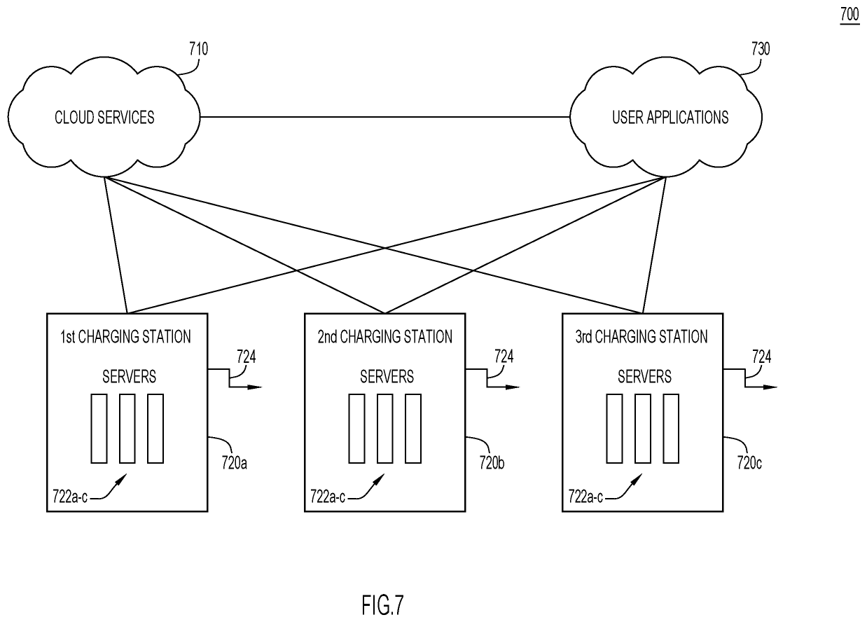

FIG. 7 is a diagram illustrating a system 700 for managing the use of charging stations, according to an example embodiment. The system 700 includes cloud services 710, a plurality of charging stations 720a-c such as a first charging station 720a, a second charging station 720b, a third charging station 720c, and user applications 730. Each charging station includes servers 722a-c and an EV charging interface 724. The number of servers 722a-c and/or charging stations 720a-c vary based on a particular deployment and use case scenario.

The cloud services 710 is a management platform that applies various machine learning techniques to determine whether a booking reservation may be granted or denied for a particular charging station and/or whether to grant or deny a request for data center resources (to perform a data center function). The cloud services 710 performs predictive planning for the charging stations 720a-c. Moreover, the charging stations 720a-c are self-adaptive i.e., determine how to distribute power between charging and performing data center functions.

The cloud services 710 determines total usage power (use at each of the charging stations 720a-c including power used by the servers 722a-c) i.e., a power use value. Additionally, the cloud services 710 determines remaining or residual power available and/or priority of the booking reservation and/or the data center function request. The cloud services 710 further determine priority of the operations being performed at the requested charging station. The cloud services 710 may then control allocation of power and task assignments to various charging stations. The cloud services 710 communicate with the user applications 730 to indicate whether the request is to be granted or denied.

The user applications 730 include user cloud portals to which users connect using various user devices to reserve a charging station e.g., via the internet network. The user applications 730 include applications installed on the user devices. The user applications 730 communicate with the cloud services 710 to determine if a booking reservation for charging an EV at a particular charging station should be granted and with the charging stations 720a-c to make the booking reservation.

In one example embodiment, the cloud services 710 receives a booking request e.g., from the user applications 730. The booking request is for charging an EV at the first charging station 720a. In related art, the user applications 730 communicate with the charging stations for reservations/use. In an example embodiment, since the charging stations 720a-c include servers 722a-c that may be executing one or more data center functions (server as a part of a distributed data center), the user applications 730 may communicate with the cloud services 710 to determine whether the booking request (reservation) may be granted. In one example embodiment, the user applications 730 communicate with a respective charging station and the respective charging station forwards the request to cloud services 710 for processing.

The cloud services 710 determine operations being performed by the servers 722a-c of the requested charging station and analyze whether the servers 722a-c may be shut down and/or operations performed thereon may be diverted to other servers housed at another charging station. Based on the foregoing, the cloud services 710 may control allocation of power to the first charging station 720a and notify the user applications 730 whether to grant or deny the booking request. If the booking request is denied, the cloud services 710 may suggest one or more alternative charging stations.

For example, the servers 722a-c of the first charging station 720a are handling time sensitive data center functions that cannot be moved to other servers at other charging stations. The cloud services 710 may then deny the booking request and suggest that the second charging station 720b is used for charging the EV. On the other hand, the cloud services 710 may determine that the data center functions handled by the servers 722a-c of the first charging station 720a is a computational task that is about to complete and/or that this computational task is peripheral and may be moved to the servers 722a-c of the second charging station 720b. In this case, the cloud services 710 moves the computational task (if required) to the servers 722a-c of the second charging station 720b and grants the booking request.

As another example, the cloud services 710 may determine that the computational task uses only a small portion of the power and that the residual power is enough to perform partial charging of the EV. As such, the cloud services 710 may indicate to the user applications 730 that only partial charging is available at the first charging station 720a. The user may then accept partial charging or slow charging mode or request a different charging station that is able to provide a regular charging mode.

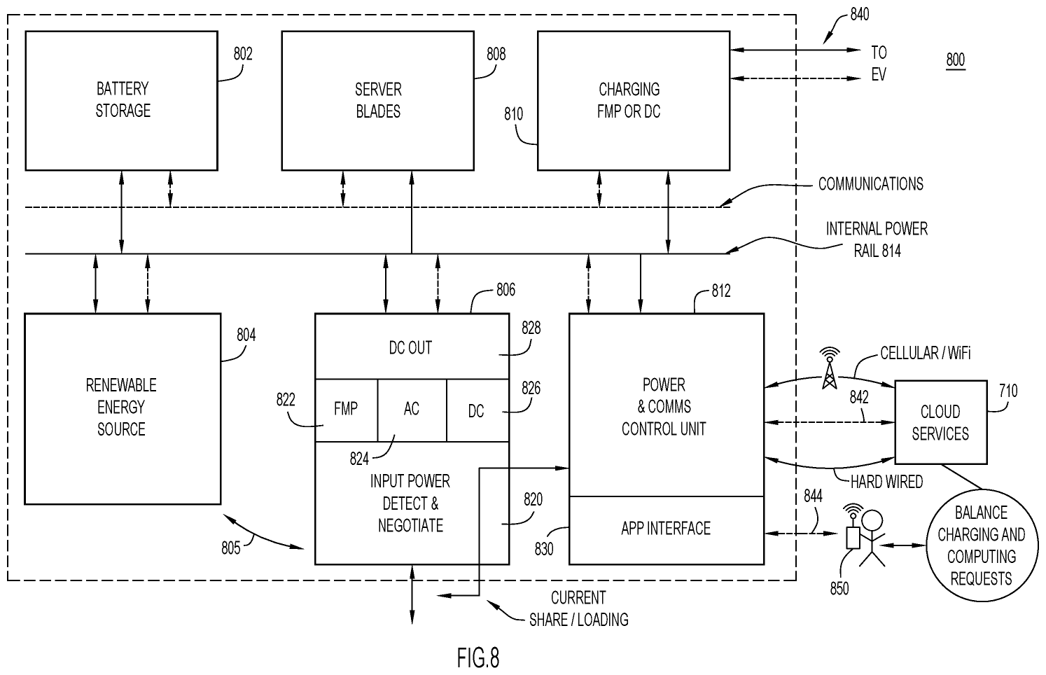

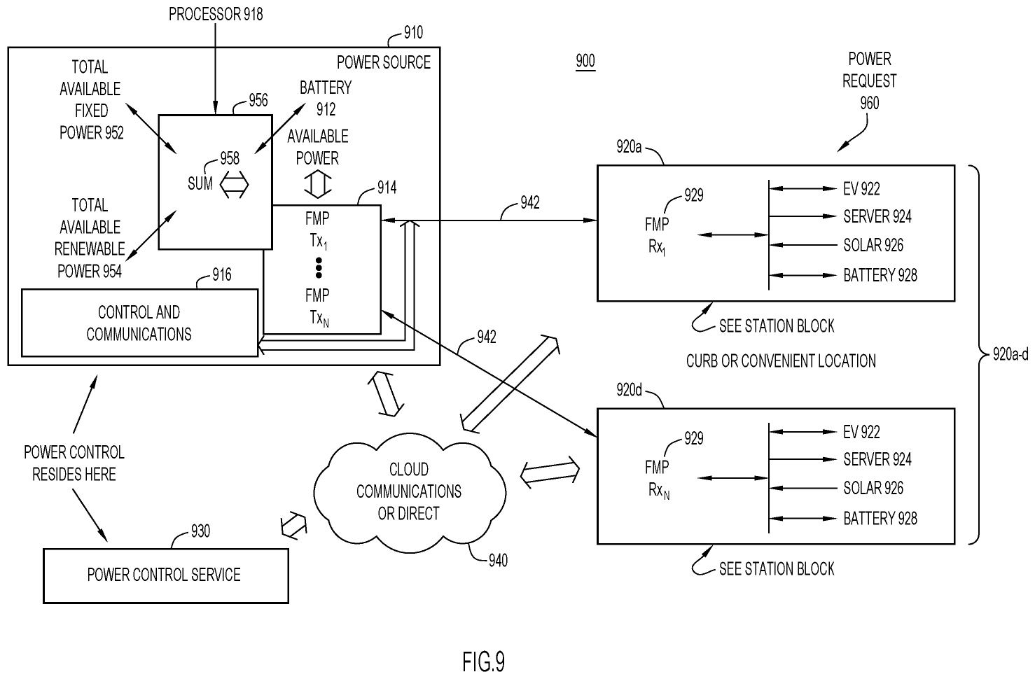

FIG. 8 is a block diagram illustrating a charging station block 800 that includes components of the charging station for power distribution and communications with the cloud services 710 of FIG. 7, according to an example embodiment. The charging station block 800 includes a battery storage 802, a renewable energy source 804 such as solar, wind, etc., a main power source 806, server blades 808, EV charging interface 810, a power and communications control unit 812, and an internal rail 814.

In one example embodiment, the internal rail 814 is an internal bus that connects the components of the charging station block 800 to one another for communication and power distribution. That is, the internal rail 814 includes power rail shown in solid black lines and communications rails shown in purpose/dashed lines. While in the charging station block 800, power and communications are shown separately, this is just an example. In one or more example embodiments, power and communications are on the same wire set (same internal rails).

The battery storage 802 supplies power from a battery to the components of the charging station via the internal rail 814. The components of the charging station include the server blades 808 that perform one or more data center functions and the EV charging interface 810 that connects to the EV, shown at 840, for data communications and/or charging a battery in the EV. While in the charging station block 800, the server blades 808 are depicted to only receive power via the internal rail 814, this is just an example. In one or more example embodiments, the server blades 808 may be bi-directional power distribution. For example, the server blades 808 may be integrated with a battery, a renewable power source, etc. such that server blades 808 supplies power to the internal rail 814 to power other components such as the EV charging interface 810.

The renewable energy source 804 supplies power from one or more renewable power sources to the components of the charging station via the internal rail 814. In one example embodiment, the renewable energy source 804 supplies power directly to the main power source 806 instead of the internal rail 814, shown at 805.

The main power source 806 supplies power from various sources e.g., utility power, to the components of the charging station via the internal rail 814. Additionally, the main power source 806 detects input power and reports the input power to the power and communications control unit 812.

The power and communications control unit 812 is configured to communicate with the cloud services 710 e.g., via a hard-wired communication lines, cellular, and/or Wi-Fi, as shown at 842.

In one example embodiment, the main power source 806 includes one or more of an FMP block 822, an AC block 824, and a DC block 826. That is, the main power source 806 receives, as input power, FMP, AC or DC. The main power source 806 converts the input power to DC power and outputs the DC power 828 onto the internal rail 814 to supply power to the components of the charging station. The main power source 806 includes an input power management component 820 that detects input power and negotiates the needed or required power to perform the workload. The workload may include charging an EV and performing one or more data center functions by the server blades 808.

The power and communications control unit 812 includes an application interface 830 that communicates via communications network(s), at 844, with a user application 850 executing on a user device e.g., i-share application. The power and communications control unit 812 is further configured to manage power balancing requests and control current sharing.

For example, the user application 850 receives user input to reserve the charging station for use i.e., to charge a battery in the EV. The user application 850 communicates with the cloud services 710 to determine not only whether the charging station is available but also whether the server blades 808 are executing services that cannot be shut down and/or diverted to another charging station. As explained above, if the services cannot be shut down, suspended, or diverted, the booking request is denied.

On the other hand, the cloud services 710 may determine that the services use only a certain amount of power e.g., approximately 50%, that is available to the charging station. The application interface 830 may then communicate to the user application 850 that partial charging (i.e., slow charging) is available. The user may then decide whether to perform slow charging (e.g., the EV is parked for the night) or whether to look for a different charging station, which can perform regular or fast charging (e.g., the EV is parked for a quick food break). The cloud services 710 balances charging requests and data center function requests (computing and/or hosting requests as a part of the distributed data center) by determining loads at the charging stations and types of services (data center functions) being handled by the respective charging station. The cloud services 710 and the user application 850 communicate with respective charging stations using the power and communications control unit 812.

FIG. 9 is a diagram illustrating a power distribution system 900 in which power is distributed among a plurality of charging stations, according to an example embodiment. The power distribution system 900 includes a power source 910, a plurality of station blocks 920a-d, and a power control service 930, which communicate via one or more networks 940.

The power source 910 includes power components of FIG. 8 such as the battery storage 802, the renewable energy source 804, and/or the main power source 806, depicted as a battery 912. The power source 910 includes a set of FMP transmitters 914, one for each station block. The set of FMP transmitters 914 are configured to transmit/supply power to a respective station block. In one example embodiment, the set of FMP transmitters 914 may supply to only some of the plurality of station blocks 920a-d and these blocks further transmit power to other station blocks that are not directly connected to the power source 910.

The power source 910 further includes power control and communications interface 916 such as the power and communications control unit 812 of FIG. 8. The power source 910 further includes a processor 918 that is configured to determine available power. Specifically, the processor 918 combines total available fixed power 952 (utility power) with total available renewable energy power 954 and with battery power 956 to compute the sum 958 or total available power. The sum 958 is the available power that is distributed or allocated among the set of FMP transmitters 914.

The plurality of station blocks 920a-d include a first station block 920a and a second station block 920d, that may be located on a curb or another convenient location for charging the EVs. An example of the station block is charging station block 800 of FIG. 8. Each station block includes an EV charging component 922, at least one server 924, solar power source 926, battery 928, and an FMP receiver 929.

That is, each station block includes an FMP receiver 929 that receives FMP power from the power source 910 via a respective one of the set of FMP transmitters 914. That is, the FMP receiver 929 is connected to the power source 910 via 10 to 100 meters or more wired connection 942. Typically, current or power share for charging stations and fast charging stations is to have a total fixed wattage or current divided equally or with some weighting across the plurality of station blocks 920a-d. However, the plurality of station blocks 920a-d include servers (e.g., the at least one server 924). As such, priority should shift to the at least one server 924 unless the EV charging component 922 forces priority through one or more methods. For example, the power request is initiated at one of the plurality of station blocks 920a-d, shown at 960, to shift priority and obtain a greater amount of power allocation.

Specifically, the power control service 930 obtains the sum 958 (total available power) from the power source 910 via one or more networks 940 and determines how to allocate and/or distribute power to the plurality of station blocks 920a-d. The power control service 930 receives requests for data center services (computing and hosting functions) and/or requests to use the charging station to charge a battery via the EV charging component 922 via the one or more networks 940. The power control service 930 then determines optimal power distribution and/or power sharing and instructs the power source 910 how to distribute power. Additionally, the power control service 930 may instruct a respective charging station to deny or grant a charging request. The power control service 930 determines how to split the available power (sum 958) among the plurality of station blocks 920a-d. The power control service 930 may be running on a cloud server and/or may be in a form of an application being executed on one or more servers.

In one example embodiment, the power source 910 is a building or a digital building power source and the plurality of station blocks 920a-d are charging stations installed in a parking lot next to the digital building. In one example embodiment, the power is shared with one or more other electric appliances in the digital building such as consumer electronic appliances.

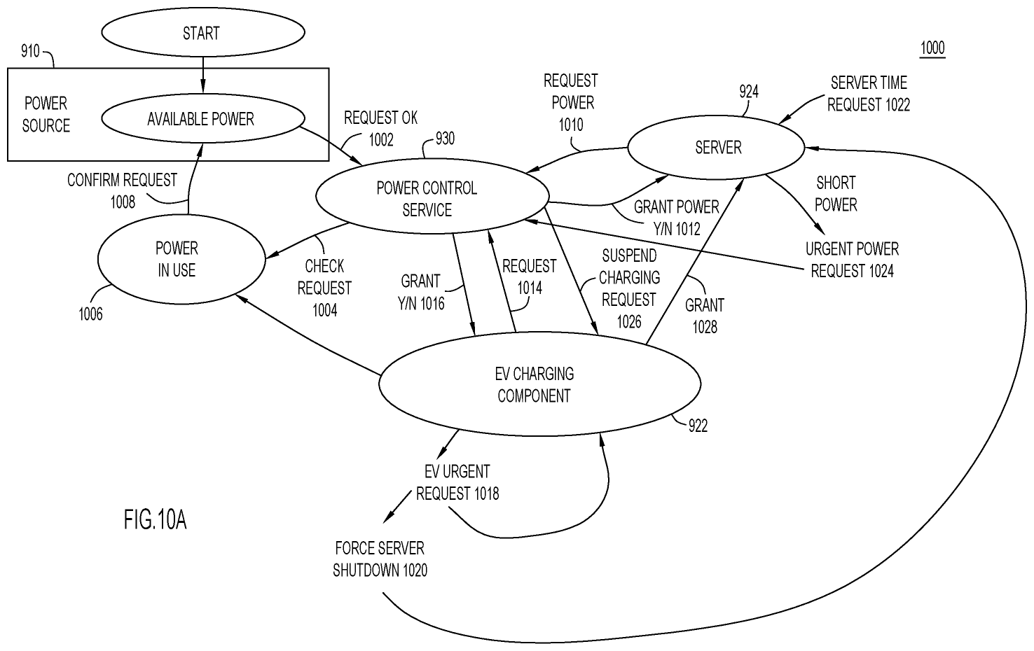

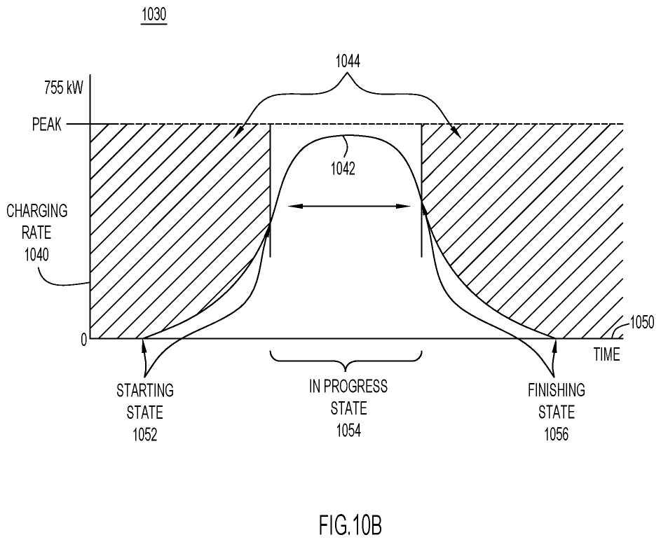

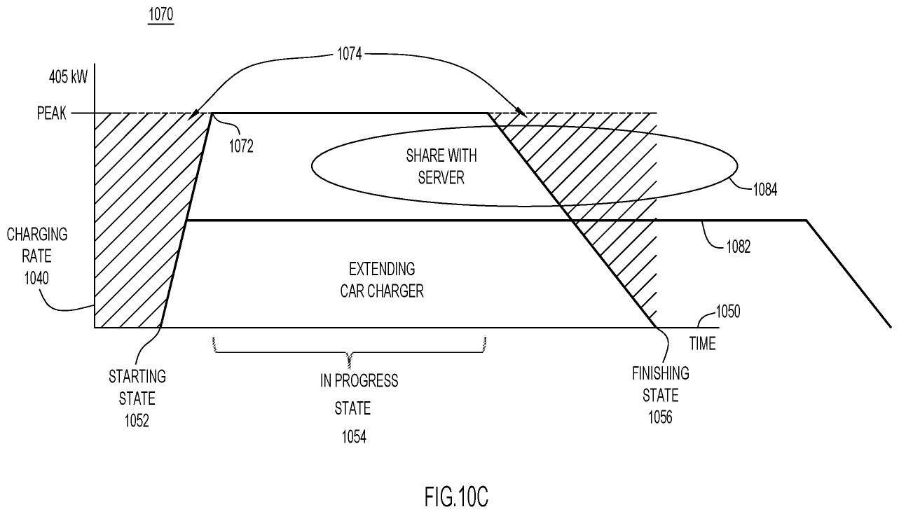

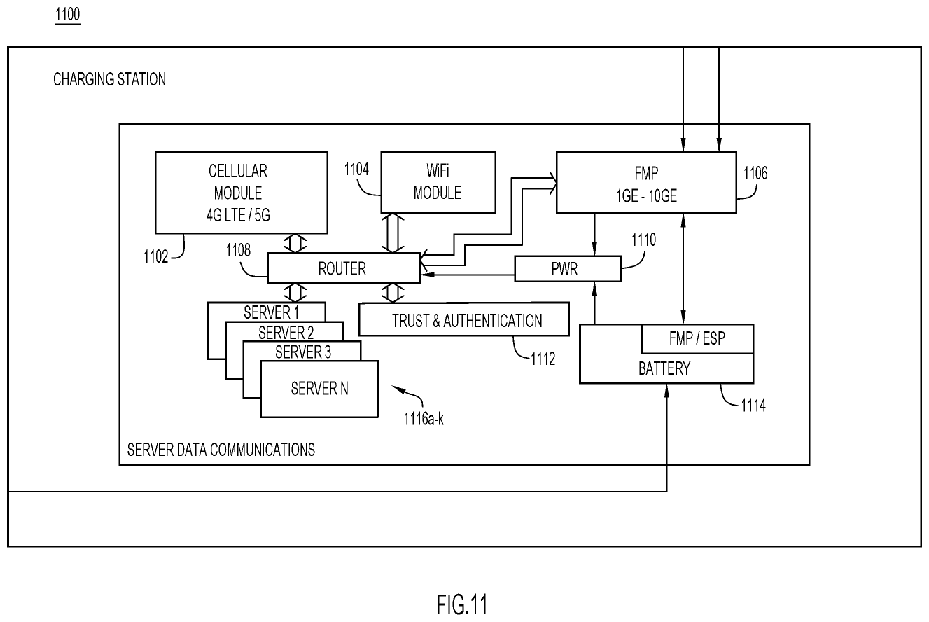

With continued reference to FIG. 9, FIG. 10A is a diagram illustrating a method 1000 of allocating and sharing power at a charging station, according to an example embodiment. The method 1000 involves the power source 910 of FIG. 9, the app or cloud server such as the power control service 930 of FIG. 9, a server housed in a charging station e.g., the at least one server 924 of FIG. 9, and the EV charging component 922 of FIG. 9.

These are just some examples of the components involved in the method 1000. The method 1000 may be implemented by the cloud services 710 of FIGS. 7 and 8 and/or user applications 730 and/or by a processor housed within a charging station.

The method 1000 is one example of power allocation and/or power/current sharing between the EV charging and server blades to allow for fair request allocation, as well as a technique to handle urgent and/or emergency requests by the EV charging and/or server blades. In one example embodiment, control and management of power is at a cloud level. In yet another example embodiment, control and management of power is performed at a local level e.g., at a controller responsible for a group of self-adaptive electric charging stations. In yet another example embodiment, the control and management of power is performed at a combination of the local level and cloud level.

The method 1000 starts at 1002 in which a residual power (presently available power) is obtained i.e., the sum 958 of FIG. 9 minus power in use. The power control service 930 obtains the present available power from the power source 910, for example. The power control service 930 may check the available power by at 1004 by generating a check request to obtain power in use at 1006, which is then subtracted from the total available power at 1008, and is provided to the power control service 930 at 1002 e.g., request ok.

At 1010, the power control service 930 obtains a request for power from the at least one server 924. At 1012, the power control service 930 grants or denies the request. The request is granted or denied based on the residual power obtained at 1002 and the required power for performing the task in the request. Similarly, at 1014, the power control service 930 receives requests from the EV charging component 922 and at 1016, the power control service 930 grants or denies the request based on the amount of residual power i.e., currently available power.

The method 1000 further involves handling one or more urgent or high priority power requests. For example, at 1018, the EV charging component 922 obtains an urgent EV charging request. In one example embodiment, the urgent EV charging request may be provided to the power control service 930 from the EV charging component 922. In this case, the power control service 930 communicates with the at least one server 924 to place the at least one server 924 on a standby mode.

At 1020, the EV charging component 922, optionally via the power control service 930, forces the at least one server 924 to suspend its operations i.e., to shut down. In one example embodiment, the at least one server 924 may switch to performing only critical operations. Provided there is now enough of available power to perform the charging, at 1016, the power control service 930 grants the urgent request.

As another example, at 1022, the data center assigns an urgent compute task related to the operations of the data center to the at least one server 924 i.e., server time request. At 1024, the at least one server 924 sends an urgent power request to the power control service 930. At 1026, the power control service 930 may temporarily suspend the charging by the EV charging component 922 and/or switch the EV charging component 922 to a low charging mode (reduce power to the EV charging component 922. Based on amount of the residual power i.e., by shutting down charging performed by the EV charging component 922, at 1028, the power control service 930 grants the server time request.

In one or more example embodiment, the power control service 930 determines the available power for the use by determining power required for charging the battery of the electric vehicle based on a charging profile and a charging state. The charging profile varies depending on whether it is for the fast charging mode, the regular charging mode, or the slow charging mode. Additionally, during charging, different amount of power is used. For example, typically at a starting state and finishing state of charging, the EV charging component 922 requires less power than during the middle of charging i.e., an in progress state (charging the battery between 20% to 80%).

FIGS. 10B and 10C are views illustrating a first power use profile 1030 and a second power use profile 1070, respectively, for charging an electric vehicle, according to one or more example embodiments. The first power use profile 1030 is for fast charging and the second power use profile 1070 is for regular charging. The first power use profile 1030 and the second power use profile 1070 include power use 1040 on the y-axis e.g., in kW and time 1050 (charging states) on the x-axis.

The first power use profile 1030 involves a starting state 1052 e.g., 0 to 5 minutes, in which only a small amount of power is used e.g., under 20 kW. The first power use profile 1030 then proceed to an in progress state 1054 or the middle of charging in which fast charging is performed. The in progress state 1054 may involve 5 to 10 minutes but completes about 50% of the charging e.g., from ˜20% to 70% of the EV battery charge. In the in progress state 1054, power use may be 650 kW, for example of a maximum available ˜755 kW. In the finishing state 1056, the power used is reduced i.e., to 20 kW, for example. The power use for charging the EV in fast charging mode is shown at 1042. Based on the first power use profile 1030, the self-adaptive electric charging station allocates residual power to one or more server blades, shown at 1044. Specifically, the servers are provided with more power while the charging station charges in the starting state 1052 and finishing state 1056. The servers are then switched to a standby mode or low power mode when the charging station charges in the in progress state 1054.

The second power use profile 1070 is for regular charging. The starting state 1052 and the finishing state 1056 are shorter in time and mainly, the charging is at the in progress state 1054 i.e. ˜350 kW of the maximum available ˜405 kW. The power in use is shown at 1072 and available power for the servers at 1074.

In one or more example embodiments, the EV charging may be extended or switched to a low power mode shown at 1082. The power is then shared between the charging at 1082 and the server blades, at 1084. For example, when an urgent time sensitive request is received from one of the servers in the charging station, the charging power is reduced to allow the servers to perform the time sensitive request.

FIG. 11 is a block diagram illustrating components of the charging station based data center 1100, according to an example embodiment. The charging station based data center 1100 includes a cellular module 1102, a Wi-Fi module 1104, FMP module 1106, a router 1108, a power module 1110, a trust and authentication module 1112, a battery with FMP module 1114, and servers 1116a-k.

The cellular module 1102 and the Wi-Fi module 1104 are in communication with the router 1108. The router 1108 is in communication with the servers 1116a-k (Server 1, Server 2, Server 3, Server K). In one example, power and data are received from the EV or another external device and power and communications are split at the FMP module 1106. The FMP module 1106 may transmit data at 1GE-10GE to the router 1108 and transmit power to power module 1110, for example. In another example, the charging station based data center 1100 receives data from a connected EV. The FMP module 1106 may include a bi-directional FMP connection with battery with the FMP module 1114. The power module 1110 may transmit battery power to the battery of the connected EV or the servers 1116a-k. The power module 1110 may include an FMP receiver (not shown) for receiving FMP (power and data).

The charging station based data center 1100 may also include the trust and authentication module 1112 to provide authentication with the power system before data transfer is permitted. When the EV is connected to the charging station, the two devices may mutually authenticate with one another. In one example, point-to-point communications may then be protected using MACsec (security). The servers 1116a-k may also mutually authenticate with one another. Individual server blades may be authenticated separately. If layer 3 IP (Internet Protocol) communication is used, once the IP is setup, higher layers can then use IP and TLS (Transport Layer Security) for secure communications rather than MACsec. In one or more embodiments, the trust and authentication module 1112 may be configured for IEEE 802.1x and EAP (Extensible Authentication Protocol)-TLS authentication using IEEE 802.1AR device identify to provide initial certificate based mutual device identification. In another example, IEEE 802.1x, MACsec may be used to provide continuous in-flight message confidentiality and authentication.

Data center costs are driven by power (required power, backup power, electrical and power distribution equipment), land and building costs (construction, maintenance, permits, taxes), cooling costs (cooling equipment and power to drive the cooling equipment), network connectivity (e.g., fiber optic connections), and repair, infrastructure maintenance, and upgrade costs. If a data center is placed in one or more charging stations, many of these requirements and costs may be eliminated. For example, use of charging station based data center in place of a conventional data center eliminates the cost of land, building infrastructure, local and backup power. Maintenance and server updates may be performed during regularly scheduled maintenance and software updates of the charging stations.

In one or more example embodiments, the charging station may include an external camera and a cabinet sensor, to prevent unauthorized access to servers (e.g., to steal). An artificial intelligence (AI) program detects anomalies such as cabinet opening, people staying too close to the cabinet, etc.

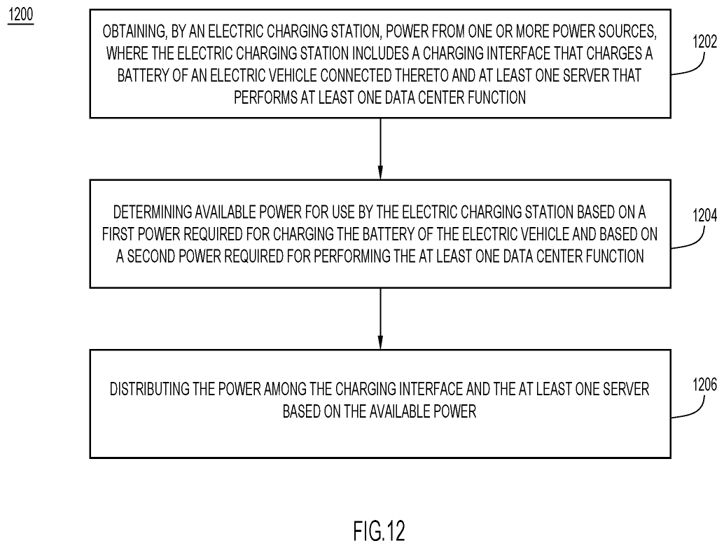

FIG. 12 is a flowchart illustrating a method 1200 of performing at least one data center function and/or charging an electric vehicle, by a dual purpose electric charging station, according to an example embodiment.

The method 1200 involves, at 1202, obtaining, by an electric charging station, power from one or more power sources. The electric charging station includes a charging interface that charges a battery of an electric vehicle connected thereto and at least one server that performs at least one data center function.

The method 1200 further involves, at 1204, determining available power for use by the electric charging station based on a first power required for charging the battery of the electric vehicle and based on a second power required for performing the at least one data center function.

The method 1200 further includes at 1206, distributing the power among the charging interface and the at least one server based on the available power.

In one form, the method 1200 may further include, based on a request to charge the battery of the electric vehicle connected to the charging interface, providing the power to the charging interface and changing an operating state of the at least one server to a standby mode or reducing the power being supplied to the at least one server.

In another form, the method 1200 may further include, based on a request to charge the battery of the electric vehicle connected to the charging interface, providing the power to the charging interface and providing a residual amount of the power to the at least one server to perform the at least one data center function.

In yet another form, the method 1200 may further include, based on a request to perform a computing or hosting function of a distributed data center, reducing the power supplied to the charging interface and providing a residual amount of the power to the at least one server to perform the computing or hosting function.

According to one or more example embodiments, the power may include one or more of an alternating current (AC) power or a direct current (DC) power. The method 1200 may further include converting the power to a fault managed power that is supplied to the charging interface and the at least one server.

In one instance, the electric charging station may be a residential charging station. The method 1200 may further include determining an amount of the fault managed power to allocate to the electric charging station based on power use by one or more residential electric appliances.

In another instance, the operation 1204 of determining the available power for the use by the electric charging station may include determining the first power required for charging the battery of the electric vehicle based on a charging profile and a charging state. The charging profile may be for one of a fast charging mode, a regular charging mode, or a slow charging mode. The charging state may be one of a starting state, an in progress state, and a finishing state.

According to one or more example embodiments, the method 1200 may further involve determining a priority of a request to perform the at least one data center function and switching the charging interface to the slow charging mode based on the priority of the request.

According to one or more example embodiments, the method 1200 may further include suspending operations of the at least one server that performs the at least one data center function based on determining that the charging interface is charging the battery of the electric vehicle in the fast charging mode and is at the in progress state.

In one form, the operation 1202 of the power from the one or more power sources may include obtaining the power from the battery of the electric vehicle to distribute the power to the at least one server to continue operations while the charging interface is not receiving the power. In one example, none of the power may be distributed to the charging interface. That is, the electric vehicle may not be charged while the battery of the EV is powering the server blades.

FIG. 13 is a hardware block diagram of a computing device 1300 that may perform functions associated with any combination of operations in connection with the techniques depicted in FIGS. 1-12, according to various example embodiments, including, but not limited to, operations of a server blade e.g., a computing device that host various functions of a distributed data center. It should be appreciated that FIG. 13 provides only an illustration of one embodiment and does not imply any limitations with regard to the environments in which different embodiments may be implemented. Many modifications to the depicted environment may be made.

In at least one embodiment, computing device 1300 may include one or more processor(s) 1302, one or more memory element(s) 1304, storage 1306, a bus 1308, one or more network processor unit(s) 1310 interconnected with one or more network input/output (I/O) interface(s) 1312, one or more I/O interface(s) 1314, and control logic 1320. In various embodiments, instructions associated with logic for computing device 1300 can overlap in any manner and are not limited to the specific allocation of instructions and/or operations described herein.

In at least one embodiment, processor(s) 1302 is/are at least one hardware processor configured to execute various tasks, operations and/or functions for computing device 1300 as described herein according to software and/or instructions configured for computing device 1300. Processor(s) 1302 (e.g., a hardware processor) can execute any type of instructions associated with data to achieve the operations detailed herein. In one example, processor(s) 1302 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1304 and/or storage 1306 is/are configured to store data, information, software, and/or instructions associated with computing device 1300, and/or logic configured for memory element(s) 1304 and/or storage 1306. For example, any logic described herein (e.g., control logic 1320) can, in various embodiments, be stored for computing device 1300 using any combination of memory element(s) 1304 and/or storage 1306. Note that in some embodiments, storage 1306 can be consolidated with one or more memory elements 1304 (or vice versa), or can overlap/exist in any other suitable manner.

In at least one embodiment, bus 1308 can be configured as an interface that enables one or more elements of computing device 1300 to communicate in order to exchange information and/or data. Bus 1308 can be implemented with any architecture designed for passing control, data and/or information between processors, memory elements/storage, peripheral devices, and/or any other hardware and/or software components that may be configured for computing device 1300. In at least one embodiment, bus 1308 may be implemented as a fast kernel-hosted interconnect, potentially using shared memory between processes (e.g., logic), which can enable efficient communication paths between the processes.

In various embodiments, network processor unit(s) 1310 may enable communication between computing device 1300 and other systems, entities, etc., via network I/O interface(s) 1312 to facilitate operations discussed for various embodiments described herein. In various embodiments, network processor unit(s) 1310 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1300 and other systems, entities, etc. to facilitate operations for various embodiments described herein. In various embodiments, network I/O interface(s) 1312 can be configured as one or more Ethernet port(s), Fibre Channel ports, and/or any other I/O port(s) now known or hereafter developed. Thus, the network processor unit(s) 1310 and/or network I/O interface(s) 1312 may include suitable interfaces for receiving, transmitting, and/or otherwise communicating data and/or information in a network environment.

I/O interface(s) 1314 allow for input and output of data and/or information with other entities that may be connected to computing device 1300. For example, I/O interface(s) 1314 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 1316, a display screen, or the like.

In various embodiments, control logic 1320 can include instructions that, when executed, cause processor(s) 1302 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a housing and a network interface configured to enable network communications. The apparatus further includes an electric charging interface configured to connect to an electric vehicle to charge a battery of the electric vehicle. The apparatus further includes at least one server that is housed within the housing and includes at least one processor configured to perform one or more data center functions. The apparatus further includes a power module that distributes power to the electric charging interface and to the at least one server.

In one form, the at least one server may include a plurality of server blades. The apparatus may further include a server housing that stores the plurality of server blades in an air sealed space.

In one instance, the housing may include an opening that provides an access to the plurality of server blades. The apparatus may further include a lifting mechanism configured to move the server housing below a ground level for storage and above the ground level for the access by a user via the opening.

In another instance, the server housing may be a server depository that stores at least one replacement server blade of the plurality of server blades. The at least one replacement server blade may be configured to be deployed in the electric vehicle.

According to one or more example embodiments, the server housing may include at least one indicator that indicates that a faulty electric vehicle type server blade is stored therein.

In one form, the plurality of server blades may further include at least one charging station type server blade that forms a part of a distributed data center.

According to one or more example embodiments, the power module may provide the power to the at least one server to perform the one or more data center functions while the electric charging interface is not charging the battery of the electric vehicle.

In one instance, the power module may distribute the power to the electric charging interface to charge the battery of the electric vehicle and to the at least one server to perform the one or more data center functions.

In another instance, the power module may allocate a first amount of the power to the electric charging interface to perform charging of the battery of the electric vehicle in a slow charging mode while the at least one server performs a computing function for a distributed data center.

According to one or more example embodiments, the apparatus may be a self-adaptive electric charging station in which the power module distributes the power among the electric charging interface and the at least one server based on reservation information related to the electric charging interface and current power use data of the electric charging interface and the at least one server.

In yet another example embodiment, a system is provided. The system includes a plurality of electric charging stations. Each of the plurality of electric charging stations includes an electric charging interface that connects to an electric vehicle to charge a battery of the electric vehicle. At least two charging stations of the plurality of electric charging stations include one or more servers that are configured to perform one or more data center functions of a distributed data center. The system further includes a power source that supplies power to the plurality of electric charging stations and a cloud service that controls the power source to distribute the power among the plurality of electric charging stations to charge one or more electric vehicles connected thereto and to perform the one or more data center functions of the distributed data center.

In one form, the cloud service may be configured to obtain a first request for charging the battery of the electric vehicle and a second request for performing a computing or hosting function of the distributed data center and to determine distribution of the power among the plurality of electric charging stations based on the first request and the second request.

In another form, the cloud service may determine a power use value based on the power being used by the plurality of electric charging stations to charge the one or more electric vehicles and may control the power source to supply residual power to the one or more servers based on the power use value.

According to one or more example embodiments, the cloud service may obtain information related to a reservation of one or more of the plurality of electric charging stations for charging and may perform predictive planning for distributing the power among the electric charging interface and the one or more servers of the plurality of electric charging stations.

In yet another example embodiment, an apparatus may include a memory, a network interface configured to enable network communications, and a processor. The processor is configured to perform various operations described in FIGS. 1-13.

In yet another example embodiment, one or more non-transitory computer readable storage media encoded with instructions are provided. When the media is executed by a processor, the instructions cause the processor to execute various operations described in FIGS. 1-13.

In yet another example embodiment, a system is provided that includes the devices and operations explained above with reference to FIGS. 1-13.

The programs described herein (e.g., control logic 1320) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1306 and/or memory elements(s) 1304 can store data, software, code, instructions (e.g., processor instructions), logic, parameters, combinations thereof, and/or the like used for operations described herein. This includes the storage 1306 and/or memory elements(s) 1304 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. An apparatus comprising:
a housing;
a network interface configured to enable network communications;
an electric charging interface configured to connect to an electric vehicle to charge a battery of the electric vehicle;
at least one server that is housed within the housing and includes at least one processor configured to perform one or more data center functions; and
a power module that distributes power to the electric charging interface and to the at least one server.

2. The apparatus of claim 1, wherein the at least one server includes a plurality of server blades and further comprising:
a server housing that stores the plurality of server blades in an air sealed space.

3. The apparatus of claim 2, wherein the housing includes an opening that provides an access to the plurality of server blades and further comprising:
a lifting mechanism configured to move the server housing below a ground level for storage and above the ground level for the access by a user via the opening.

4. The apparatus of claim 2, wherein the server housing is a server depository that stores at least one replacement server blade of the plurality of server blades, and the at least one replacement server blade is configured to be deployed in the electric vehicle.

5. The apparatus of claim 4, wherein the server housing includes at least one indicator that indicates that a faulty electric vehicle type server blade is stored therein.

6. The apparatus of claim 4, wherein the plurality of server blades further include at least one charging station type server blade that forms a part of a distributed data center.

7. The apparatus of claim 1, wherein the power module provides the power to the at least one server to perform the one or more data center functions while the electric charging interface is not charging the battery of the electric vehicle.

8. The apparatus of claim 1, wherein the power module distributes the power to the electric charging interface to charge the battery of the electric vehicle and to the at least one server to perform the one or more data center functions.

9. The apparatus of claim 1, wherein the power module allocates a first amount of the power to the electric charging interface to perform charging of the battery of the electric vehicle in a slow charging mode while the at least one server performs a computing function for a distributed data center.

10. The apparatus of claim 1, wherein the apparatus is a self-adaptive electric charging station in which the power module distributes the power among the electric charging interface and the at least one server based on reservation information related to the electric charging interface and current power use data of the electric charging interface and the at least one server.

11. A method comprising:
obtaining, by an electric charging station, power from one or more power sources, wherein the electric charging station includes a charging interface that charges a battery of an electric vehicle connected thereto and at least one server that performs at least one data center function;
determining available power for use by the electric charging station based on a first power required for charging the battery of the electric vehicle and based on a second power required for performing the at least one data center function; and
distributing the power among the charging interface and the at least one server based on the available power.

12. The method of claim 11, further comprising:
based on a request to charge the battery of the electric vehicle connected to the charging interface, providing the power to the charging interface and changing an operating state of the at least one server to a standby mode or reducing the power being supplied to the at least one server.

13. The method of claim 11, further comprising:
based on a request to charge the battery of the electric vehicle connected to the charging interface, providing the power to the charging interface and providing a residual amount of the power to the at least one server to perform the at least one data center function.

14. The method of claim 11, further comprising:
based on a request to perform a computing or hosting function of a distributed data center, reducing the power supplied to the charging interface and providing a residual amount of the power to the at least one server to perform the computing or hosting function.

15. The method of claim 11, wherein the power includes one or more of an alternating current (AC) power or a direct current (DC) power and further comprising:
converting the power to a fault managed power that is supplied to the charging interface and the at least one server.

16. The method of claim 15, wherein the electric charging station is a residential charging station and further comprising:
determining an amount of the fault managed power to allocate to the electric charging station based on power use by one or more residential electric appliances.

17. The method of claim 11, wherein determining the available power for the use by the electric charging station includes:
determining the first power required for charging the battery of the electric vehicle based on a charging profile and a charging state,
wherein the charging profile is for one of a fast charging mode, a regular charging mode, or a slow charging mode and the charging state is one of a starting state, an in progress state, and a finishing state.

18. The method of claim 17, further comprising:
determining a priority of a request to perform the at least one data center function; and
switching the charging interface to the slow charging mode based on the priority of the request.

19. The method of claim 17, further comprising:
suspending operations of the at least one server that performs the at least one data center function based on determining that the charging interface is charging the battery of the electric vehicle in the fast charging mode and is at the in progress state.

20. The method of claim 11, wherein obtaining the power from the one or more power sources includes:
obtaining the power from the battery of the electric vehicle to distribute the power to the at least one server to continue operations while the charging interface is not receiving the power.

21. A system comprising:
a plurality of electric charging stations, each of which includes an electric charging interface that connects to an electric vehicle to charge a battery of the electric vehicle, wherein at least two charging stations of the plurality of electric charging stations include one or more servers that are configured to perform one or more data center functions of a distributed data center;
a power source that supplies power to the plurality of electric charging stations; and
a cloud service that controls the power source to distribute the power among the plurality of electric charging stations to charge one or more electric vehicles connected thereto and to perform the one or more data center functions of the distributed data center.

22. The system of claim 21, wherein the cloud service is configured to obtain a first request for charging the battery of the electric vehicle and a second request for performing a computing or hosting function of the distributed data center and determine distribution of the power among the plurality of electric charging stations based on the first request and the second request.

23. The system of claim 21, wherein the cloud service determines a power use value based on the power being used by the plurality of electric charging stations to charge the one or more electric vehicles and controls the power source to supply residual power to the one or more servers based on the power use value.

24. The system of claim 21, wherein the cloud service obtains information related to a reservation of one or more of the plurality of electric charging stations for charging and performs predictive planning for distributing the power among the electric charging interface and the one or more servers of the plurality of electric charging stations.
